(19) United States
(12) Patent Application Publication
(10) Pub. No.: US 2003/0059696 A1
(43) Pub. Date: Mar. 27, 2003

(54) Endless flexible, single-layer, positively charged organic photosensitive body and an image forming device using the same

(76) Inventors: Osamu Nabeta, Nagano (JP); Shinichi Omokawa, Nagano (JP); Hirotaka Kobayashi, Nagano (JP); Toshio Tsubota, Nagano (JP)

Correspondence Address: DARBY & DARBY P.C., POST OFFICE BOX 5257, NEW YORK, NY, 10150-5257, US

(21) Appl. No.: 10/076,049

(22) Filed: Feb. 13, 2002

(30) Foreign Application Priority Data
Feb. 15, 2001 (JP) 2001-038748

(51) Int. Cl. G03G 5/04

(52) U.S. Cl. 430/96; 430/78

(57) ABSTRACT

The object of the present invention is to provide an endless flexible single-layer positively charged organic photosensitive body and an image forming device using the same, wherein: in an image forming device that is small, high speed and capable of color output, even when tension and compression forces, which are generated by having the photosensitive body stretched between a plurality of cylindrical rollers, are repeatedly applied to the belt photosensitive body, no problems arise in the electrophotography properties of the photosensitive layer.

The present invention is an endless flexible single-layer positively charged organic photosensitive body, wherein: a photosensitive layer, which has main construction material of a charge generating agent, a hole transport agent, an electron transport agent, and a resin binder, is formed on top of a flexible support body; the charge generating agent contains mainly titanyl phthalocyanine; and the resin binder contains polycarbonate resin as a main resin.

### BACKGROUND TO THE INVENTION

The present invention relates to an endless flexible type (henceforth referred to as belt-type) single-layer positively charged organic photosensitive body used in monochrome and color printers with electrophotography systems, copiers, facsimiles, light printing presses and the like. In addition, the present invention relates to an image forming device that uses this belt-type photosensitive body.

Image forming devices that use electrophotography systems are capable of high speed processing and can achieve high quality images. Because of this, these image forming devices are widely used in printers, copiers, facsimiles, and the like that are mainly for office use.

In recent years, there has been interest in expanding the market for these image forming devices into devices capable of color output and light printing presses as described later. With this aim, there has been much technical development into achieving high resolution, high contrast, and high speed. The results from these developments have been incorporated into image forming devices, and there has been active progress in their market expansion.

With these market movements, improvements based on the technical developments described above have been made in the field of the photosensitive body, which is at the very heart of the image forming devices. These improvements have centered on the organic photosensitive body, which is the mainstream.

This type of organic photosensitive body is largely divided into a layered type and a single layer type. The layered type has a charge generating layer that has a charge generating function and a charge transport layer that has charge transport function. The single layer type has one layer that has both a charge generating function and a charge transport function.

The former has a structure in which a charge generating layer and a charge transport layer are laminated in that order on top of a conductive cylindrical support body of aluminum and the like. It is mainly used in image forming devices of negatively charged processes. The latter has a layer structure in which a single layer photosensitive layer is provided similarly on top of a conductive cylindrical support body of aluminum and the like. It is mainly used in image forming devices of positively charged processes.

Because a semiconductor laser of a wavelength 700-800 nm or a light emitting diode of wavelength 600-700 nm is used as the light exposure source of the image forming device, both the single layer type and the layered type mostly use phthalocyanine compounds, particularly metal-free phthalocyanine, for the charge generating agent.

With regard to the photosensitive body, in the prior art, a negatively charged photosensitive body drum of the laminated type has been mainly used in various image forming devices because of its superior sensitivity, responsiveness, and printing resistant surface compared to that of the single layer type.

On the other hand, as described previously, electrophotography image forming devices can achieve high quality images with high speed processing, but currently, with faster processing and improved image quality, the device becomes large, heavy, and more expensive. In particular, with high speed printers, high speed copiers, facsimiles, and color capable machines of these, and light printing presses and the like, there is the problem of increased size and number of the construction members. Research into reducing the size and reducing the number of parts has been very important.

As a means for miniaturization, instead of the drum-shaped photosensitive body, a belt-type organic photosensitive body is used. In this belt-type organic photosensitive body, a photosensitive layer is formed on top of a support body that is a flexible sheet such as a high molecular weight film or the like, and this is joined in an endless manner. This endless flexible (belt type) organic photosensitive body has a large degree of freedom in its shape and placement due to its flexible nature. As a result, this is an extremely effective photosensitive body for achieving miniaturization of the device. Recently, there has been a great push towards the development and production of belt type organic photosensitive bodies.

The belt type organic photosensitive body can be divided into the following types. For example, as described in Japanese Laid-Open Patent Publication Number 62-50871, Japanese Laid-Open Patent Publication Number 5-269850, Japanese Laid-Open Patent Publication Number 8-30001, and the like, after forming an organic photosensitive layer on a high molecular weight film of polyester or the like, both ends of the film are joined into an endless shape by ultrasonic wave fusion, heat fusion method, and the like. In this type, the photosensitive layer is formed on a belt-shaped substrate that is of a joined type. Japanese Laid-Open Patent Number 63-127249, Japanese Laid-Open Patent Number 3-219259, and the like describe a metal seamless belt substrate of nickel and the like, and Japanese laid-Open Patent Number 7-178795, Japanese Laid-Open Patent Number 11-170389 describe a conductive seamless belt in which a conductive powder of carbon black and the like are dispersed in polyester, polyimide, fluororesin and the like. In this type, the photosensitive layer is formed on these seamless belt substrates.

The former has the advantage of being manufactured at a lower cost than a photosensitive body of the latter. However, the joining part is uneven in height and cannot be an image forming region. As a result, the image forming device must be devised to avoid the joining part for image formation. This results in an increased cost for the entire device. With this type, improvements for having the least amount of unevenness in the joining part are important, and various strategies have been employed.

Because the latter has no uneven joining part as in the former photosensitive body, it is not necessary to devise a device that avoids a joining part. However, the seamless belt substrate itself is expensive, and this results in an increased cost for the photosensitive body. With this type, there has been an effort to improve materials and manufacturing methods in order to lower the costs for the substrate.

There has also been progress made in the photosensitive body for increasing the speed and miniaturizing the image forming device. In the prior art, the single layer photosensitive body has been considered to have an inadequate charge transport function. A new electron transporting agent that adequately satisfies the electron transport function at a practical level has been developed. With this electron transporting agent, there has been a dramatic improvement in the single layer photosensitive body characteristics. Examples of this new electron transport agent include organic compounds of a diphenoquinone derivative described in Japanese Laid-Open Patent Number 6-118670, a dioxotetracenedione derivative described in Japanese Laid-Open Patent Number 9-77763, a tryptoanthryne imine derivative as described in Japanese Laid-Open Patent Number 9-87283, a naphthoquinone derivative as described in Japanese Laid-Open Patent Number 9-151157, a stilbene quinone derivative as described in Japanese Laid-Open Patent Number 9-281729, and the like. Due to the development of these new materials, the performance of the single layer type has dramatically improved. With the single layer type of the prior art, image forming devices that have a greatly reduced ozone production amount can be manufactured cheaply. Taking advantage of this characteristic, there has been even more activity into the product development of printers, copiers, and fax machines that use single layer organic photosensitive bodies. In addition, the single layer organic photosensitive body is superior in terms of resolution and contrast compared to the layered type. As a result, there has been an attempt at expansion into image forming devices that are capable of color output, as described previously.

Furthermore, with the use in figures and in light printing presses, inorganic photosensitive bodies, such as selenium photosensitive bodies and amorphous silicon photosensitive bodies, which are used in positively charged processes are widely mounted in the prior art. However, the possibility of substituting belt-type single layer organic photosensitive bodies even in these fields has emerged because they can be used in the same positively charged processes and are inexpensive.

However, currently, with regard to the photosensitive layer, even with the belt type organic photosensitive body, the laminated-type negatively charging photosensitive layer is still the mainstream. The problems of ozone generation and inadequate resolution and contrast still remain. Regardless of whether a seam (joining part) is present or not, if a belt-type single-layer positively charged organic photosensitive body is developed, the realization of an image forming device that has little ozone generation, has a high quality image, and is small and inexpensive can be anticipated. Therefore, in the future, it is predicted that the belt-type single layer positively charged organic photosensitive body will be very important for use in high speed printers, high speed copiers, fax machines, and color capable devices of these, as well as light printing presses.

This belt type positively charged organic photosensitive body has a large number of advantages as described above, but as shown below, there are problems specific to the belt-type photosensitive body which uses a single-layer positively charged organic photosensitive layer.

The first problem is that although the sensitivity and responsiveness of the single- layer positively charged organic photosensitive body is sufficiently increased, in order to mount this photosensitive body as a belt type into a high speed printer, high speed copier, fax machine, and their color capable machines, as well as light printing presses, and the like, the photosensitive layer does not have enough strength to withstand the specific tension and compression force that is applied to a belt type photosensitive body.

We will further describe this point below. As described above, the single-layer positively charged organic photosensitive body has a greatly improved performance as a result of the development of an electron transport agent having a high mobility, such as naphthoquinone and the like. However, in order to have a sensitivity, responsiveness, and printing resistance that is suitable for a high speed printer, high speed copier, and their color capable machines, as well as light printing presses, and the like, the electron generating ability, hole transport ability, and electron transport ability can be maintained at a high level only by increasing the content of the charge generating agent, hole transport agent, and electron transport agent in the single layer film.

In this manner, the belt-type single layer positively charged organic photosensitive body is equipped with a photosensitive layer that has a high mixing ratio of charge generating agent, hole transport agent, and electron transport agent and has a relatively low mixing ratio of resin binder, which is the layer forming material. As a result, its strength as a film is weak. Therefore, when this belt type photosensitive body is installed and operated in a high speed machine, color capable machine, printing press, and the like, it cannot withstand the tension which is specific to the belt type as it is stretched between a plurality of cylindrical rollers. Cracks and breaks in the photosensitive layer can occur readily. Furthermore, due to the compression force from members (for example, charging roller, charging brush, developing roller, paper, transfer roller, cleaning blade, and the like) that contact this belt photosensitive body, cracks and bending in the photosensitive layer can also occur easily.

The second problem is that with a single-layer positively charged photosensitive body, the charge generating region resulting from light exposure is concentrated near the photosensitive layer surface as compared to the laminated negatively charged type. As a result, when used in the belt type, even with mechanical damage of minute cracks and the like generated at the photosensitive layer surface by external forces of tension and compression force and the like as described above, this can cause a large loss in the photosensitive body properties, and the photosensitive body cannot withstand actual use. With regard to this point, we will describe in detail using known examples.

A concrete example of a belt-type single-layer positively charged organic photosensitive body is the belt photosensitive body described in Japanese Laid-Open Patent Number 8-152723. According to the embodiment in this publication, a photosensitive layer that uses a tris azo compound as a charge generating agent, a stilbene compound as a hole transport agent, a bisphenol Z-type polycarbonate of viscosity average molecular weight 50,000 as a resin binder is formed. Single layer type photosensitive bodies with differing weight ratios of the resin binder in the photosensitive layer were studied. By having the weight ratio of the resin binder be such that the glass transition temperature of this photosensitive layer is 85 degrees or greater, the cracks and film peeling, which are normally generated with the repeated operation of the belt photosensitive body while stretched over a plurality of cylindrical roller, are eliminated.

However, the single-layer photosensitive body described in this publication does not have a structure that contains both titanyl phthalocyanine, which increases the sensitivity, and an electron transport agent. As a result, the photosensitive body is of a low quality that does not satisfy the sensitivity and responsiveness needed for the high speed machines, color capable machines, and light printing presses as described above. Furthermore, by simply using a bisphenol Z type polycarbonate and having a glass transition temperature for this single layer film at 85 degrees or greater, the strength is not enough to sustain the strong tension on the photosensitive body with high speed operation of the photosensitive body while mounted on a small high speed machine, color capable machine, light printing press and the like of the present invention.

Currently, in order to have high speed image processing in the high speed machines, color capable machines, light printing presses, and the like, the size of the photosensitive body is increased, and the circumferential speed of the photosensitive body is increased. Normally, a corotron or a scorotron and the like are used for the charging system, but when using a belt-type laminated negatively charged organic photosensitive body, which is currently the mainstream, ozone generation from this corotron, scorotron, and the like become problematic. The introduction of an exhaust system as a way to respond to this problem results in a greatly increased cost for the device. Furthermore, when using this belt-type laminated negatively charged organic photosensitive body, the image quality does not achieve the resolution and contrast needed, especially for color output machines.

A third problem is that with high speed machines, color capable machines, and light printing presses that use the belt-type positively charged organic photosensitive body, this belt photosensitive body must have a high tension between the rollers of 50N/cm or greater per unit length of the width of the belt photosensitive body. This is in order to prevent the riding up of the photosensitive body onto the cylindrical rollers due to slippage or winding and the like arising during rotation of this belt type photosensitive body. With the belt-type single-layer positively charged organic photosensitive body of the prior art, because the film strength of the photosensitive layer was weak, breakage and the like of the photosensitive layer as described above was evident.

A fourth problem is that in order to have smaller devices for these high speed machines, color capable machines, and light printing presses, and the like, there is a need for the outer diameter of the cylindrical rollers to be 20 mm phi or less. This condition has already been implemented for the laminated-type belt photosensitive body. However, with the single-layer positively charged organic photosensitive body, particularly with the small diameter rollers, there is a strong tension in the winding part of the roller. Obvious cracks arise in the photosensitive layer, and this problem has not been solved.

### OBJECTS AND SUMMARY OF THE INVENTION

Upon considering the above points, the object of the present invention is to provide an endless flexible single-layer positively charged organic photosensitive body and an image forming device using the same, wherein: in an image forming device that is small, high speed and capable of color output, even when tension and compression forces, which are generated by having the photosensitive body stretched between a plurality of cylindrical rollers, are repeatedly applied to the belt photosensitive body, no problems arise in the electrophotography properties of the photosensitive layer.

According to an embodiment of the present invention, the above objective is achieved by an endless flexible single-layer positively charged organic photosensitive body, wherein: a photosensitive layer, which has main construction material of a charge generating agent, a hole transport agent, an electron transport agent, and a resin binder, is formed on top of a flexible support body; the charge generating agent contains mainly titanyl phthalocyanine; and the resin binder contains polycarbonate resin as a main resin.

According to a feature of the present invention, it is preferable to have an endless flexible single-layer positively charged organic photosensitive body, wherein: the polycarbonate resin has a viscosity average molecular weight of 20,000 or greater; and/or a weight ratio of the polycarbonate resin in the photosensitive layer is 40% or greater and 70% or less.

According to another feature of the present invention, it is preferable to have an endless flexible single-layer positively charged organic photosensitive body as described above, wherein the polycarbonate resin is a bisphenol Z-type polycarbonate resin.

According to another embodiment of the present invention, the above objective is achieved by an image forming device, comprising: an endless flexible single-layer positively charged organic photosensitive body, as described above, that is stretched between a plurality of cylindrical rollers by a tension of 50 N/cm or greater per unit length of the width of the photosensitive body; and means for electrophotography processing that are placed on the periphery of the photosensitive body.

According to a feature of the present invention, it is preferable to have an image forming device, comprising: an endless flexible single-layer positively charged organic photosensitive body, as described above, that is stretched over a plurality of cylindrical rollers that include at least one cylindrical roller with an outer diameter of 5 mm Φ or greater and 20 mm Φ or less; and means for electrophotography processing that are placed on the periphery of the photosensitive body.

According to a feature of the present invention, it is preferable to have an image forming device, comprising: an endless flexible single-layer positively charged organic photosensitive body, as described above, that is stretched with a tension of 50 N/cm per unit length of the width of the photosensitive body and is stretched over a plurality of cylindrical rollers that include at least one cylindrical roller with an outer diameter of 5 mm Φ or greater and 20 mm Φ or less; and means for electrophotography processing that are placed on the periphery of the photosensitive body.

According to another feature of the present invention, it is preferable to have an image forming device, as described above, wherein: the image forming device is a device selected from a printer, copier, fax machine, and printing press that are capable of color output by an electrophotography method.

Although its theoretical basis has not been adequately confirmed, a further surprising effect is seen when titanyl phthalocyanine is used as a charge generating agent. When the photosensitive body is operated continuously while being stretched across cylindrical rollers, the cracking resistance with respect to the tension between the stretching rollers and the compression force from the contact parts is improved. In addition, even if cracks are generated in the photosensitive layer surface, any change in the photosensitive body properties is kept to a very small amount.

Furthermore, as described above, with the electrophotography system high speed printers, high speed copiers, fax machines, and their color capable machines, and light printing presses and the like, the problems had included ozone that was generated during their use and the increased cost due to the installation of an exhaust system to overcome this problem. In the image forming device of the present invention, a flexible single-layer positively charged organic photosensitive body is used, and this photosensitive body is stretched across a plurality of cylindrical rollers. Means for electrophotography processing, such as charging, light exposure, developing, transferring, cleaning, and the like, are placed near this photosensitive body. With this image forming device, it has the added benefit of solving these problems with ozone. Similarly, the image forming device of the above structure achieves the improved image quality of high resolution and high contrast that is desired for the high speed machines and color capable machines.

With the device in which the endless flexible photosensitive body is mounted, for the purposes of preventing slippage and winding of the photosensitive body, the image forming device has a tension between the rollers of 50 N/cm or greater per unit length of the width of the photosensitive body. With this device, by mounting the endless flexible single layer positively charged organic photosensitive body of the above structure, damage to the photosensitive body during use is suppressed.

The endless flexible single layer positively charged organic photosensitive body described above is stretched across a plurality of cylindrical rollers, and even if at least one of the rollers has an outer diameter of 5 mm phi or greater and 20 mm phi or less, miniaturization of the device can be achieved. In addition, in printers, copiers, and printing presses that are capable of color output, the damage to the photosensitive body during use can similarly be suppressed as described above.

The above, and other objects, features, and advantages of the present invention will become apparent from the following description read in conjunction with the accompanying drawings, in which like reference numerals designate the same elements.

### BRIEF DESCRIPTION OF THE FIGURES

FIG. 1 is a perspective view of an endless flexible single-layer positively charged organic photosensitive body with a seam relating to an embodiment of the present invention.

FIG. 2 is a perspective view of a seamless endless flexible single-layer positively charged organic photosensitive body relating to an embodiment of the present invention.

FIG. 3 is a structural schematic diagram of an image forming device that uses a photosensitive body relating to an embodiment of the present invention.

### DETAILED DESCRIPTION OF THE INVENTION

Below, referring to the figures, concrete embodiments of the present invention are described.

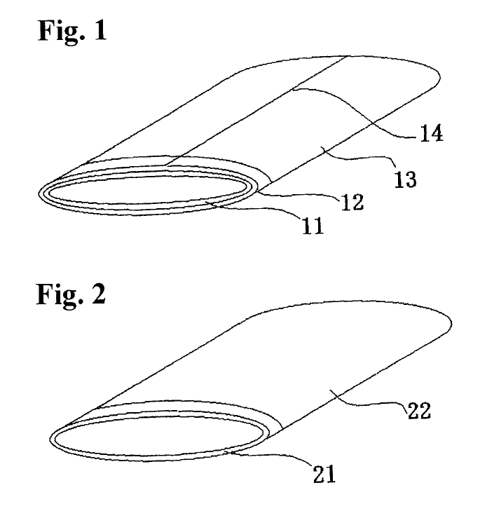

Referring to FIGS. 1 and 2, endless flexible type (belt type) single layer positively charged organic photosensitive bodies of the present invention are shown.

Referring to FIG. 1, there is shown a perspective view of an endless flexible single-layer positively charged organic photosensitive body of a type that has a joining part (seam part) 14 as described above. A conductive layer 12 and a photosensitive layer 13 are formed in that order on top of a support body 11 that is of a flexible high molecular weight film. For this high molecular weight film support body 11, a high molecular weight film of polyester, polycarbonate, and the like with a thickness of 50 μm-200 μm, and preferably 75-150 μm is used. For conductive layer 12, the following are used: a layer with a film thickness of around 500-2000 Å formed using aluminum, gold, nickel and the like by a vacuum deposition method, electron beam method, sputtering method, and the like; a layer formed by coating with a conductive coating material in which a conductive powder of carbon black and the like is dispersed in polyester resin and the like; or a layer in which a metal foil of aluminum and the like is laminated onto this high molecular weight film. Among these, a conductive layer of a metal thin film formed by deposition of aluminum is most preferred.

Referring to FIG. 2, there is a perspective view of an endless flexible single- layer positively charged organic photosensitive body that does not have a joining part as described above. A photosensitive layer 22 is formed on top of a conductive belt support body 21. For this support body, the following are preferred: a seamless belt of nickel, stainless steel and the like with a thickness of 10-100 μm that is molded into a cylindrical shaped body with a specified diameter; a resin seamless belt of a conductive resin in which conductive powder of carbon black and the like is dispersed in polycarbonate resin, polyester resin, fluororesin, polyimide resin and the like, and this resin being molded into a flexible, cylindrical shape.

Referring to FIGS. 1 and 2, the photosensitive layer shown contains a charge generating agent, charge transport agent, and resin binder, as well as additives such as oxidation inhibiting agent, ultraviolet light absorbing agent, and the like as needed. For the charge generating agent, titanyl phthalocyanine compound is the main component, and other compounds, such as known phthalocyanines, perylene compounds, dis azo compounds, tris azo compounds, squarillium compounds, dibromoanthanthrone compounds and the like, can be added as needed. The following formula (1) shows a chemical formula for a titanyl phthalocyanine that is a charge generating agent related to the present invention.

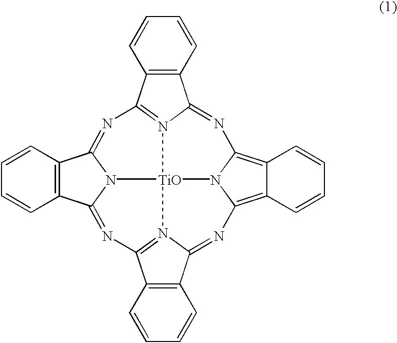

Various crystal types, modified crystal types, amorphous types of titanyl phthalocyanine are known. For example, as described in Japanese Examined Patent Publication Number 7-97221, there is a titanyl phthalocyanine having a maximum diffraction peak of 2 θ=27.3±0.2 degrees in a powder X-ray diffraction that uses Cu-Kα rays. From Japanese Laid-Open Patent Publication Number 1-123868, a titanyl phthalocyanines that does not have a clear diffraction peak between 2 θ=5 degrees to 40 degrees is known. In addition, from Japanese Laid-Open Patent Publication Number 61-239248, a titanyl phthalocyanine having strong diffraction peaks at 2θ=7.5±0.2 degrees, 12.3±0.2 degrees, 16.3±0.2 degrees, 25.3±0.2 degrees, 28.7±0.2 degrees is known. These three types of titanyl phthalocyanine are used in the embodiments of the present invention described below. Similarly, as a comparative example of a charge generating agent, a metal-free phthalocyanine, which is often used in single-layer positively charged photosensitive bodies of the prior art, is used. From these results, the importance of the titanyl phthalocyanine used in the present invention should be clear.

For the charge transport agent, there are hole transport agents and electron transport agents. For the former, distyryl compounds, diamine compounds, hydrazone compounds, stilbene compounds, and other known hole transport agents and the like are used. For the latter, stilbene quinone compounds, diphenoquinone compounds, azoquinone compounds, naphthoquinone compounds, and other known electron transport agents are used.

In addition, for the present invention, the use of electron transport agents, which was not used in the single layer positively charged photosensitive bodies of the prior art, is an important element. Therefore, comparative examples do not contain electron transport agents.

Chemical formulas for the preferred hole transport agents and electron transport agents for the present invention are shown below.

For the distyryl compounds, the following have been determined to be suitable, but the present invention is not limited to these.

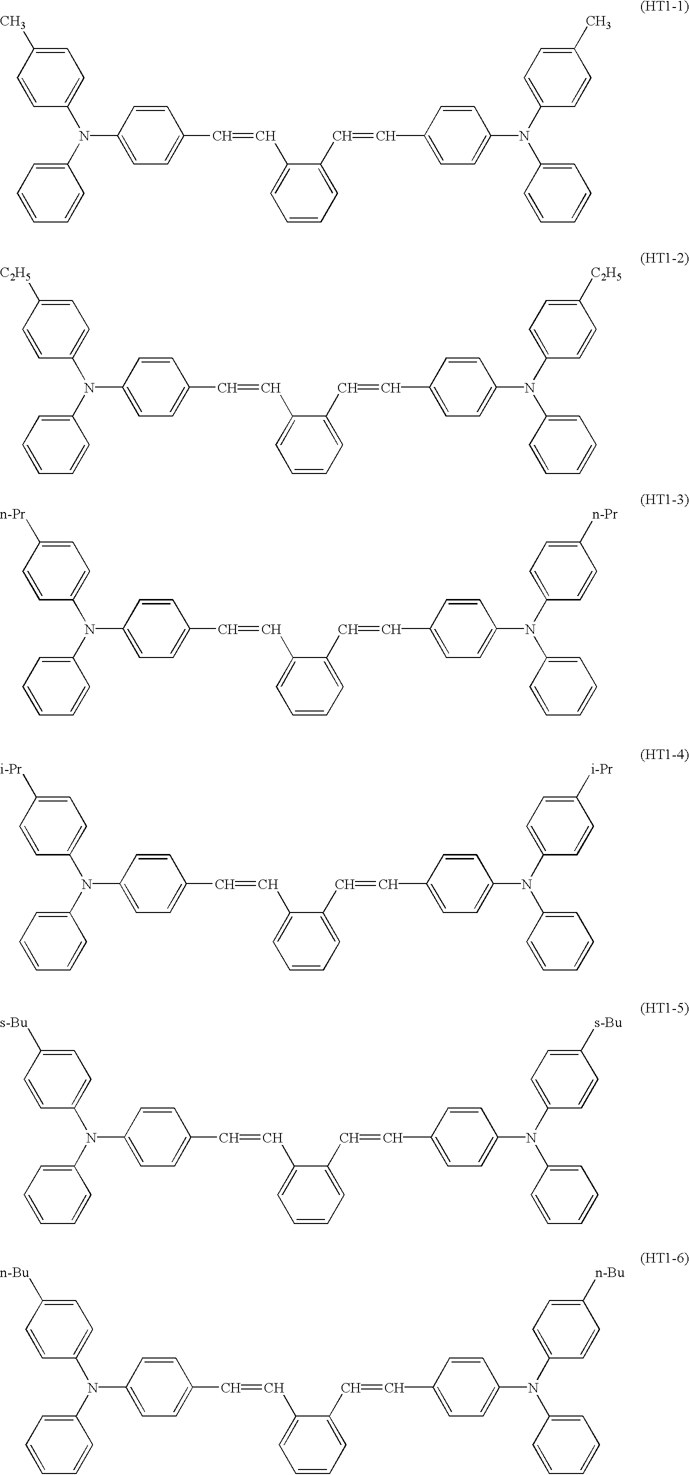

For the diamine compounds, the following have been determined to be suitable, but the present invention is not limited to these.

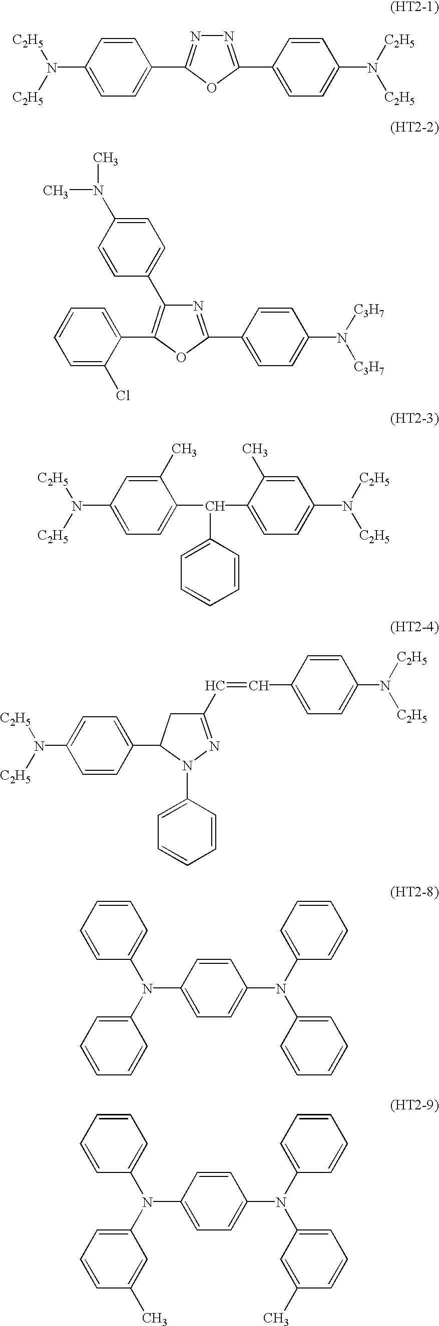

For the hydrazone compounds, the following have been determined to be suitable, but the present invention is not limited to these.

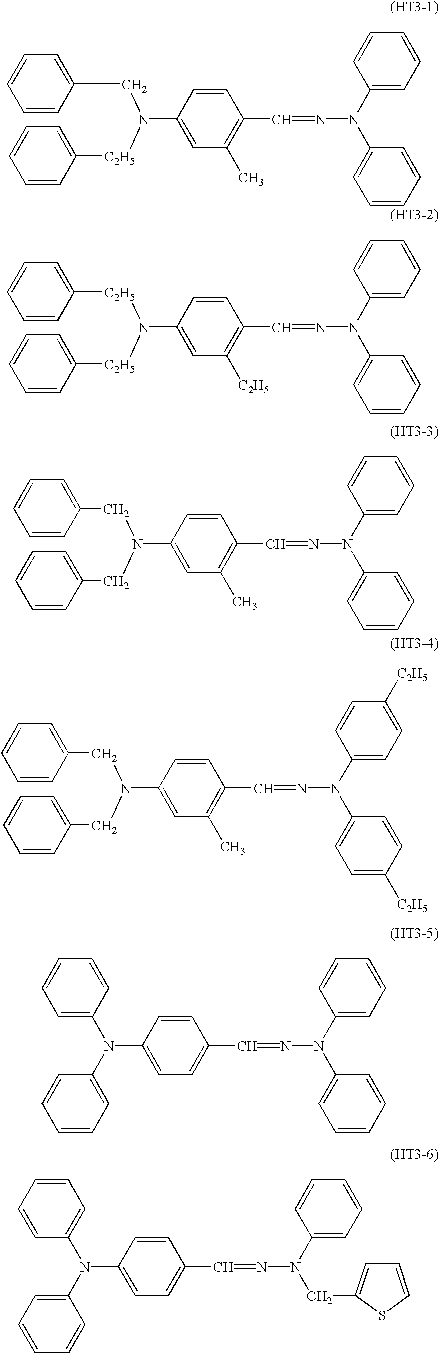

For the stilbene compounds, the following have been determined to be suitable, but the present invention is not limited to these.

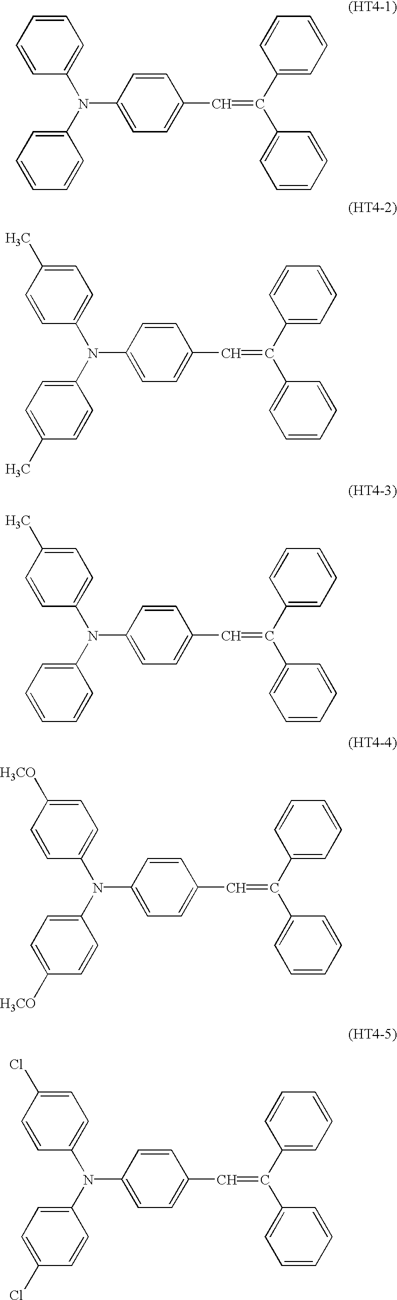

For the azoquinone compounds, the following have been determined to be suitable, but the present invention is not limited to these.

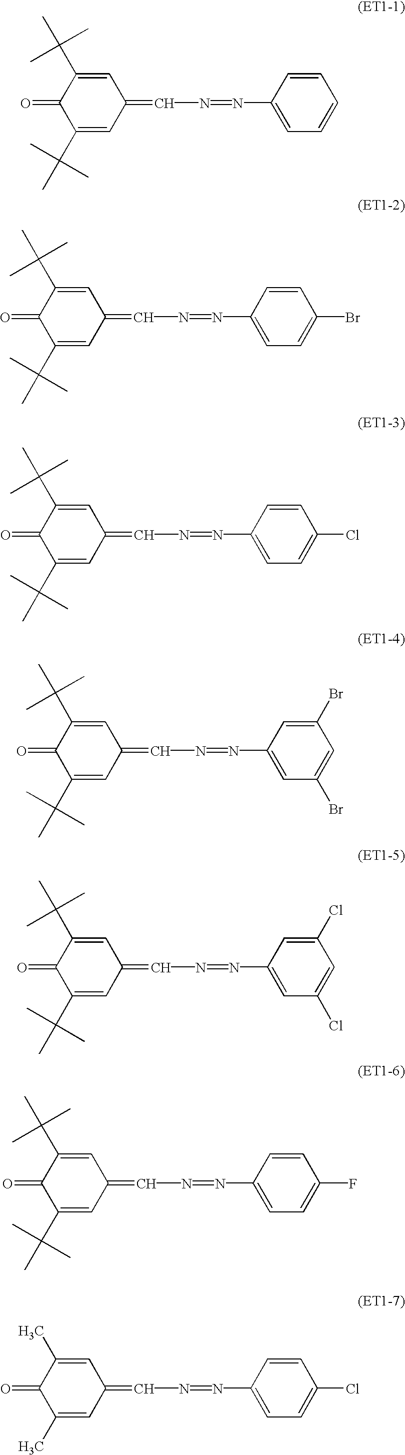

For the stilbene quinone compounds and diphenoquinone compounds, the following have been determined to be suitable, but the present invention is not limited to these.

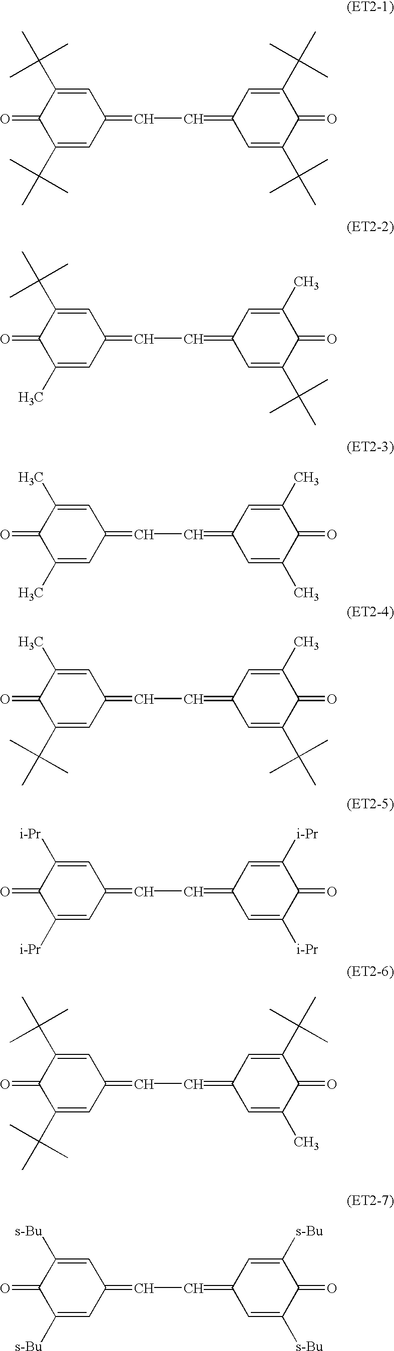

For the naphthoquinone compounds, the following have been determined to be suitable, but the present invention is not limited to these.

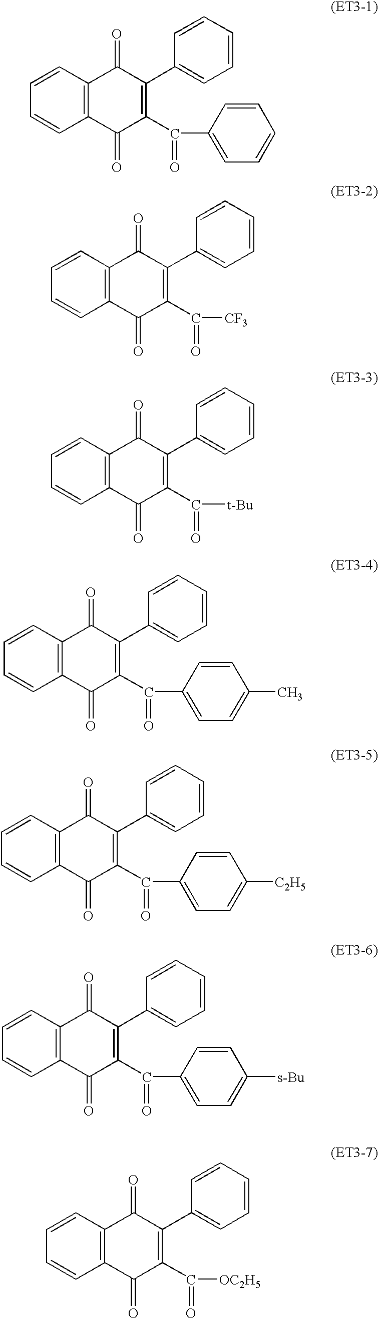

For the resin binder, polycarbonate is a main component, and polyallylate, polystyrene resin, and the like can be mixed. For superior film strength and printing resistance, there cannot be too much of resins other than polycarbonate resin. When the binder resin in the photosensitive resin, particularly polycarbonate resin, exceeds a weight ratio of 70%, the viscosity of the coating solution becomes too high. The coating operation of the photosensitive layer becomes difficult. In addition, the weight ratio for the materials that relate to the photosensitive properties becomes relatively low, and the usefulness in terms of sensitivity is reduced. When the weight ratio of the binder resin becomes 20% or lower, the usefulness in terms of strength is reduced.

Oxidation inhibiting agents and ultraviolet ray absorbing agents are used, and their addition amounts are adjusted as needed. Hindered phenol compounds and hindered amine compounds are oxidation inhibiting agents. Benzotraizole compounds and the like are ultraviolet ray absorbing agents.

A suitable polycarbonate resin of the present invention is shown below.

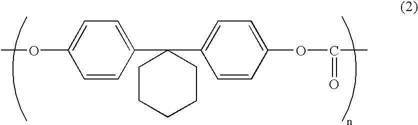

Suitable examples of a bisphenol A-biphenyl copolymer polycarbonate resin are shown below.

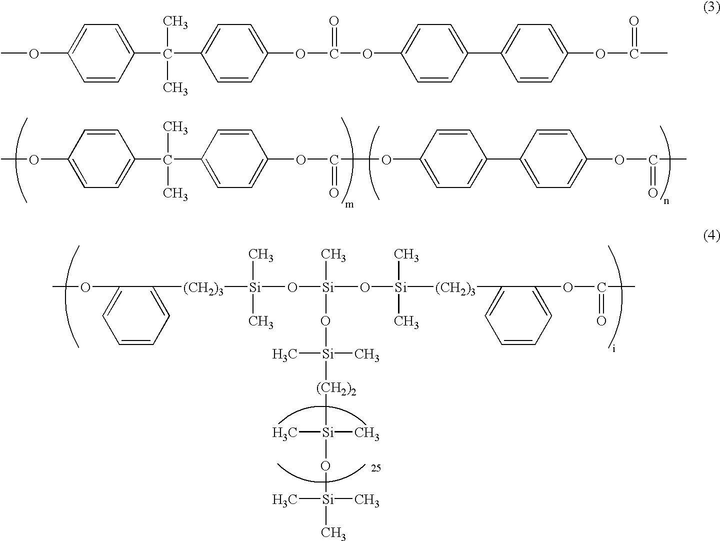

The polycarbonate resin of the present invention is not limited to the example resins shown above.

To make a coating solution, the charge generating agent, hole transport agent, electro transport agent, resin binder and the like are dissolved and/or dispersed in an organic solvent such as tetrahydrofuran, cyclohexanone, dichloromethane, methyl ethyl ketone, and the like. Using this coating solution, this photosensitive layer is formed by coating by dip method, spray method, or screen printing method, and the like.

For the purposes of strengthening the adhesion between the conductive layer and photosensitive layer and between the support body and photosensitive layer, an undercoat layer can be provided between conductive layer 12 and photosensitive layer 13 of FIG. 1 and between belt support body 21 and photosensitive layer 22 of FIG. 2. This undercoat layer is a resin film of nylon and the like or a dispersion film in which zinc oxide, zirconium oxide, titanium oxide, and the like are dispersed in this resin. In addition, for the purposes of improving printing resistance, a protective layer can be provided on top of photosensitive layer 13 and photosensitive layer 22. This protective layer is a resin film of silicone resin, urethane resin and the like, or a dispersion film in which polytetrafluoroethylene powder, titanium oxide powder and the like are dispersed in this resin.

With the endless flexible single-layer positively charged organic photosensitive body shown in FIG. 1, after coating photosensitive layer 13, both ends of the film are layered and joined to make an endless shape using ultrasonic wave fusion, heat fusion method, and the like. With the endless flexible photosensitive body of FIGS. 1 and 2, for the purposes of ensuring grounding, it is desirable to form a thin belt-shaped conductive layer on the side edge of the endless belt. This conductive layer is formed using a conductive coating material or a metal foil. Winding and slippage of this endless flexible (belt-type) photosensitive body and the like can arise during the rotation of the belt-type photosensitive body, and this can result in the riding up of the photosensitive body onto the stretching rollers. For the purposes of preventing this riding up of the photosensitive body, a rib guide, which is thin and belt-shaped (a protruding cross-section), can be placed along the entire perimeter of the back surface of this photosensitive body.

For this rib guide, for example, silicon rubber, urethane rubber and the like is used. In particular, a structure in which winding prevention is achieved by forming a groove that joins with this rib guide on the outer periphery of the stretching rollers is preferred.

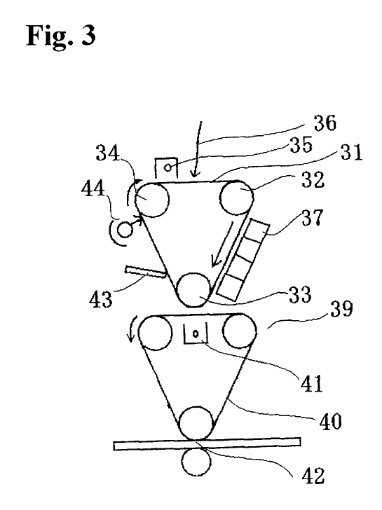

Referring to FIG. 3, there is an image forming device in which an endless flexible single layer positively charged organic photosensitive body of the present invention is mounted. Referring to FIG. 3, this is a structural schematic figure showing the relationship between the photosensitive body and the area around the photosensitive body. Referring to FIG. 3, a photosensitive body 31 is supported and stretched across cylindrical rollers 32, 33, 34, and rotates in the direction of the arrow. In the area around the photosensitive body, a charging device 35, a light exposure system 36, a developing system 37, a transfer system 39, a cleaning system 43, and a charge removal system 44 are installed. Transfer system 39 comprises an intermediate transfer belt 40 and a transfer device 41. The toner image transferred at this intermediate transfer belt is transferred to paper at a transfer part 42. Printing is completed by passing through a fixing device not shown.

Embodiments and comparative examples of the present invention are described below. With these embodiments and comparative examples, the differing crystal types of titanyl phthalocyanine, the types of polycarbonate, the molecular weights, and the composition ratios in the photosensitive layer were changed. In addition, the presence or absence of electron transport agent and the types of hole transport agents and electron transport agents were changed. For the evaluation tests, after first measuring the photosensitive body properties (sensitivity, dark attenuation rate) of the belt photosensitive body, a stretching test, a bending test, and a repeat operation test were conducted. With the stretching test, the stretching strength at which cracks were generated and the effect on the sensitivity property when cracks were generated were studied. For the bending test, the diameter of the cylindrical roller when cracks were generated and the effect on the sensitivity property when cracks were generated were studied. In addition, for the repeat operation test, the belt photosensitive body was stretched using a commercial printer and was repeatedly operated, and the number of times until cracks were generated was studied. Concrete evaluation methods are described later.

### Embodiment 1

The following photosensitive body belts of four different sizes were created: a photosensitive body sheet for the stretch test having a width of 10 mm and length of 50 mm; a photosensitive body belt for evaluating the photosensitivity body properties having a width of 250 mm and a circumference of 942 mm; a photosensitive body belt for the compression test having a width of 250 mm and a circumference of 400 mm; and a photosensitive body belt for the repeat operation test having a width of 360 mm and a circumference of 560 mm. These photosensitive body belts were created by the procedure below. All of the samples except for the photosensitive body sheet for the stretch test were made into a belt shape by implementing everything up to the joining procedure.

Preparation of the coating solution

| | | |
|---|---|---|
| 1. A titanyl phthalocyanine having a maximum diffraction peak of 2 θ = 27.3 ± | 1 | weight part |
| 0.2 degrees in a powder X-ray diffraction pattern using Cu—Kα rays (formula(1)) | | |
| 2. A hole transport agent shown in (HT1-10) | 41 | weight parts |
| 3. An electron transport agent shown in (ET2-1) | 29 | weight parts |
| 4. A bisphenol Z-type polycarbonate (formula (2)) with a viscosity average | 29 | weight parts |
| molecular weight Mv 20,000 | | |

The materials in the previous 1.-4. were added to 400 weight parts of tetrahydrofuran. This was kneaded and dispersed in a sandmill device to create the photosensitive layer coating solution.

Formation of an undercoat layer

Ten weight parts of vinyl chloride-vinyl acetate copolymer resin was dissolved in methyl ethyl ketone solvent to create an undercoat layer coating solution. The undercoat layer was formed by dip coating on top of a biaxial oriented polyester film of thickness 75 μm. The undercoat layer had a film thickness of 0.05 μm when dry.

Formation of a photosensitive layer

Next, using the photosensitive layer coating solution described above, the photosensitive layer was dip coated so that the film thickness when dry was 30 μm.

Formation of a joining part

Both ends of the sheet provided with the above photosensitive layer were joined using an ultrasonic wave fusion device. The overlapping margin of the joining part was 1 mm.

### Embodiment 2

A sample was created by the exact same procedure as Embodiment 1, except that the composition of the coating solution was changed as follows.

Preparation of the coating solution

| | | |
|---|---|---|
| 1. A titanyl phthalocyanine having a maximum diffraction peak of 2 θ = 27.3 ± | 1 | weight part |
| 0.2 degrees in a powder X-ray diffraction pattern using Cu—Kα rays (formula(1)) | | |
| 2. A hole transport agent shown in (HT1-10) | 34.5 | weight parts |
| 3. An electron transport agent shown in (ET2-1) | 24.5 | weight parts |
| 4. A bisphenol Z-type polycarbonate (formula (2)) with a viscosity average | 40 | weight parts. |
| molecular weight Mv 20,000 | | |

### Embodiment 3

A sample was created by the exact same procedure as Embodiment 1, except that the composition of the coating solution was changed as follows.

(Preparation of the coating solution)

| | | |
|---|---|---|
| 1. A titanyl phthalocyanine having a maximum diffraction peak of 2 θ = 27.3 ± | 1 | weight part |
| 0.2 degrees in a powder X-ray diffraction pattern using Cu—Kα rays (formula(1)) | | |
| 2. A hole transport agent shown in (HT1-10) | 29 | weight parts |
| 3. An electron transport agent shown in (ET2-1) | 21 | weight parts |
| 4. A bisphenol Z-type polycarbonate (formula (2)) with a viscosity average | 49 | weight parts. |
| molecular weight Mv 20,000 | | |

### Embodiment 4

A sample was created by the exact same procedure as Embodiment 1, except that the composition of the coating solution was changed as follows.

Preparation of the coating solution

| | | |
|---|---|---|
| 1. A titanyl phthalocyanine having a maximum diffraction peak of 2 θ = 27.3 ± | 1 | weight part |
| 0.2 degrees in a powder X-ray diffraction pattern using Cu—Kα rays (formula(1)) | | |
| 2. A hole transport agent shown in (HT1-10) | 23 | weight parts |
| 3. An electron transport agent shown in (ET2-1) | 17 | weight parts |
| 4. A bisphenol Z-type polycarbonate (formula (2)) with a viscosity average | 59 | weight parts. |
| molecular weight Mv 20,000 | | |

### Embodiment 5

A sample was created by the exact same procedure as Embodiment 1, except that the composition of the coating solution was changed as follows.

Preparation of the coating solution

| | | |
|---|---|---|
| 1. A titanyl phthalocyanine having a maximum diffraction peak of 2 θ = 27.3 ± | 1 | weight part |
| 0.2 degrees in a powder X-ray diffraction pattern using Cu—Kα rays (formula(1)) | | |
| 2. A hole transport agent shown in (HT1-10) | 41 | weight parts |
| 3. An electron transport agent shown in (ET2-1) | 29 | weight parts |
| 4. A bisphenol Z-type polycarbonate (formula (2)) with a viscosity average | 29 | weight parts. |
| molecular weight Mv 16,000 | | |

### Embodiment 6

A sample was created by the exact same procedure as Embodiment 1, except that the composition of the coating solution was changed as follows.

Preparation of the coating solution

| | | |
|---|---|---|
| 1. A titanyl phthalocyanine having a maximum diffraction peak of 2 θ = 27.3 ± | 1 | weight part |
| 0.2 degrees in a powder X-ray diffraction pattern using Cu—Kα rays (formula(1)) | | |
| 2. A hole transport agent shown in (HT1-10) | 34.5 | weight parts |
| 3. An electron transport agent shown in (ET2-1) | 24.5 | weight parts |
| 4. A bisphenol Z-type polycarbonate (formula (2)) with a viscosity average | 40 | weight parts. |
| molecular weight Mv 16,000 | | |

### Embodiment 7

A sample was created by the exact same procedure as Embodiment 1, except that the composition of the coating solution was changed as follows.

Preparation of the coating solution

| | | |
|---|---|---|
| 1. A titanyl phthalocyanine having a maximum diffraction peak of 2 θ = 27.3 ± | 1 | weight part |
| 0.2 degrees in a powder X-ray diffraction pattern using Cu—Kα rays (formula(1)) | | |
| 2. A hole transport agent shown in (HT1-10) | 41 | weight parts |
| 3. An electron transport agent shown in (ET2-1) | 29 | weight parts |
| 4. A bisphenol Z-type polycarbonate (formula (2)) with a viscosity average | 29 | weight parts. |
| molecular weight Mv 50,000 | | |

### Embodiment 8

A sample was created by the exact same procedure as Embodiment 1, except that the composition of the coating solution was changed as follows.

Preparation of the coating solution

| | | |
|---|---|---|
| 1. A titanyl phthalocyanine having a maximum diffraction peak of 2 θ = 27.3 ± | 1 | weight part |
| 0.2 degrees in a powder X-ray diffraction pattern using Cu—Kα rays (formula(1)) | | |
| 2. A hole transport agent shown in (HT1-10) | 34.5 | weight parts |
| 3. An electron transport agent shown in (ET2-1) | 24.5 | weight parts |
| 4. A bisphenol Z-type polycarbonate (formula (2)) with a viscosity average | 40 | weight parts. |
| molecular weight Mv 50,000 | | |

### Embodiment 9

A sample was created by the exact same procedure as Embodiment 1, except that the composition of the coating solution was changed as follows.

Preparation of the coating solution

| | | |
|---|---|---|
| 1. A titanyl phthalocyanine having a maximum diffraction peak of 2 θ = 27.3 ± | 1 | weight part |
| 0.2 degrees in a powder X-ray diffraction pattern using Cu—Kα rays (formula(1)) | | |
| 2. A hole transport agent shown in (HT1-10) | 41 | weight parts |
| 3. An electron transport agent shown in (ET2-1) | 29 | weight parts |
| 4. A bisphenol Z-type polycarbonate (formula (2)) with a viscosity average | 29 | weight parts. |
| molecular weight Mv 20,000 | | |

### Embodiment 10

A sample was created by the exact same procedure as Embodiment 1, except that the composition of the coating solution was changed as follows.

Preparation of the coating solution

| | | | |
|---|---|---|---|
| 1. | A titanyl phthalocyanine having no diffraction | 1 | weight part |
| | peaks between 2 θ = 5 to 40 degrees in a | | |
| | powder X-ray diffraction pattern using | | |
| | Cu—Kα rays (formula(1)) | | |
| 2. | A hole transport agent shown in (HT1-10) | 34.5 | weight parts |
| 3. | An electron transport agent shown in (ET2-1) | 24.5 | weight parts |
| 4. | A bisphenol Z-type polycarbonate (formula (2)) | 40 | weight parts. |
| | with a viscosity average molecular weight | | |
| | Mv 20,000 | | |

### Embodiment 11

A sample was created by the exact same procedure as Embodiment 1, except that the composition of the coating solution was changed as follows.

Preparation of the coating solution

| | | | |
|---|---|---|---|
| 1. | A titanyl phthalocyanine having no diffraction | 1 | weight part |
| | peaks between 2 θ = 5 to 40 degrees in a | | |
| | powder X-ray diffraction pattern using | | |
| | Cu—Kα rays (formula(1)) | | |
| 2. | A hole transport agent shown in (HT1-10) | 29 | weight parts |
| 3. | An electron transport agent shown in (ET2-1) | 21 | weight parts |
| 4. | A bisphenol Z-type polycarbonate (formula (2)) | 49 | weight parts. |
| | with a viscosity average molecular weight | | |
| | Mv 20,000 | | |

### Embodiment 12

A sample was created by the exact same procedure as Embodiment 1, except that the composition of the coating solution was changed as follows.

Preparation of the coating solution

| | | |
|---|---|---|
| 1. | A titanyl phthalocyanine having no diffraction peaks between 2 θ = 5 to 40 | 1 weight part |
| | degrees in a powder X-ray diffraction pattern | |
| | using Cu-Kα rays (formula (1)) | |
| 2. | A hole transport agent shown in (HT1-10) | 23 weight parts |
| 3. | An electron transport agent shown in (ET2-1) | 17 weight parts |
| 4. | A bisphenol Z-type polycarbonate (formula (2)) with a viscosity average | 59 weight parts. |
| | molecular weight Mv 20,000 | |

### Embodiment 13

A sample was created by the exact same procedure as Embodiment 1, except that the composition of the coating solution was changed as follows.

Preparation of the coating solution

| | | |
|---|---|---|
| 1. | A titanyl phthalocyanine having no diffraction peaks between 2 θ = 5 to 40 | 1 weight part |
| | degrees in a powder X-ray diffraction pattern using | |
| | Cu-Kα rays (formula (1)) | |
| 2. | A hole transport agent shown in (HT1-10) | 41 weight parts |
| 3. | An electron transport agent shown in (ET2-1) | 29 weight parts |
| 4. | A bisphenol Z-type polycarbonate (formula (2)) with a viscosity average | 29 weight parts. |
| | molecular weight Mv 16,000 | |

### Embodiment 14

A sample was created by the exact same procedure as Embodiment 1, except that the composition of the coating solution was changed as follows.

Preparation of the coating solution

| | | |
|---|---|---|
| 1. | A titanyl phthalocyanine having no diffraction peaks between 2 θ = 5 to 40 | 1 weight part |
| | degrees in a powder X-ray diffraction pattern using | |
| | Cu-Kα rays (formula (1)) | |
| 2. | A hole transport agent shown in (HT1-10) | 34.5 weight parts |
| 3. | An electron transport agent shown in (ET2-1) | 24.5 weight parts |
| 4. | A bisphenol Z-type polycarbonate (formula (2)) with a viscosity average | 40 weight parts. |
| | molecular weight Mv 16,000 | |

### Embodiment 15

A sample was created by the exact same procedure as Embodiment 1, except that the composition of the coating solution was changed as follows.

Preparation of the coating solution

| | | |
|---|---|---|
| 1. | A titanyl phthalocyanine having no diffraction peaks between 2 θ = 5 to 40 | 1 weight part |
| | degrees in a powder X-ray diffraction pattern using | |
| | Cu-Kα rays (formula (1)) | |
| 2. | A hole transport agent shown in (HT1-10) | 41 weight parts |
| 3. | An electron transport agent shown in (ET2-1) | 29 weight parts |
| 4. | A bisphenol Z-type polycarbonate (formula (2)) with a viscosity average | 29 weight parts. |
| | molecular weight Mv 50,000 | |

### Embodiment 16

A sample was created by the exact same procedure as Embodiment 1, except that the composition of the coating solution was changed as follows.

Preparation of the coating solution

1. A titanyl phthalocyanine having no diffraction peaks between 2θ=5 to 40 degrees in a powder X-ray diffraction pattern using Cu-Kα rays (formula(1))

Preparation of the coating solution

| | | |
|---|---|---|
| 1. | A titanyl phthalocyanine having no diffraction peaks between 2 θ = 5 to 40 | 1 weight part |
| | degrees in a powder X-ray diffraction pattern using | |
| | Cu-Kα rays (formula (1)) | |
| 2. | A hole transport agent shown in (HT1-10) | 34.5 weight parts |
| 3. | An electron transport agent shown in (ET2-1) | 24.5 weight parts |
| 4. | A bisphenol Z-type polycarbonate (formula (2)) with a viscosity average | 40 weight parts. |
| | molecular weight Mv 50,000 | |

### Embodiment 17

A sample was created by the exact same procedure as Embodiment 1, except that the composition of the coating solution was changed as follows.

Preparation of the coating solution

| | | |
|---|---|---|
| 1. | A titanyl phthalocyanine having strong diffraction peaks at 2 θ = 7.5 ± 0.2 | 1 weight part |
| | degrees, 12.3 ± 0.2 degrees, 16.3 ± 0.2 degrees, | |
| | 25.3 ± 0.2 degrees, 28.7 ± 0.2 degrees | |
| | in a powder X-ray diffraction pattern using Cu-Kα rays (formula (1)) | |
| 2. | A hole transport agent shown in (HT1-10) | 41 weight parts |
| 3. | An electron transport agent shown in (ET2-1) | 29 weight parts |
| 4. | A bisphenol Z-type polycarbonate (formula (2)) with a viscosity average | 29 weight parts. |
| | molecular weight Mv 20,000 | |

### Embodiment 18

A sample was created by the exact same procedure as Embodiment 1, except that the composition of the coating solution was changed as follows.

Preparation of the coating solution

| | | |
|---|---|---|
| 1. | A titanyl phthalocyanine having strong diffraction peaks at 2 θ = 7.5 ± 0.2 | 1 weight part |
| | degrees, 12.3 ± 0.2 degrees, 16.3 ± 0.2 degrees, | |
| | 25.3 ± 0.2 degrees, 28.7 ± 0.2 degrees | |
| | in a powder X-ray diffraction pattern using Cu-Kα rays (formula (1)) | |
| 2. | A hole transport agent shown in (HT1-10) | 34.5 weight parts |
| 3. | An electron transport agent shown in (ET2-1) | 24.5 weight parts |
| 4. | A bisphenol Z-type polycarbonate (formula (2)) with a viscosity average | 40 weight parts. |
| | molecular weight Mv 20,000 | |

### Embodiment 19

A sample was created by the exact same procedure as Embodiment 1, except that the composition of the coating solution was changed as follows.

Preparation of the coating solution

| | | |
|---|---|---|
| 1. | A titanyl phthalocyanine having strong diffraction peaks at 2 θ = 7.5 ± 0.2 | 1 weight part |
| | degrees, 12.3 ± 0.2 degrees, 16.3 ± 0.2 degrees, | |
| | 25.3 ± 0.2 degrees, 28.7 ± 0.2 degrees | |
| | in a powder X-ray diffraction pattern using Cu-Kα rays (formula (1)) | |
| 2. | A hole transport agent shown in (HT1-10) | 29 weight parts |
| 3. | An electron transport agent shown in (ET2-1) | 21 weight parts |
| 4. | A bisphenol Z-type polycarbonate (formula (2)) with a viscosity average | 49 weight parts. |
| | molecular weight Mv 20,000 | |

### Embodiment 20

A sample was created by the exact same procedure as Embodiment 1, except that the composition of the coating solution was changed as follows.

Preparation of the coating solution

| | | |
|---|---|---|
| 1. | A titanyl phthalocyanine having strong diffraction peaks at 2 θ = 7.5 ± 0.2 | 1 weight part |
| | degrees, 12.3 ± 0.2 degrees, 16.3 ± 0.2 degrees, | |
| | 25.3 ± 0.2 degrees, 28.7 ± 0.2 degrees | |
| | in a powder X-ray diffraction pattern using Cu-Kα rays (formula (1)) | |
| 2. | A hole transport agent shown in (HT1-10) | 23 weight parts |
| 3. | An electron transport agent shown in (ET2-1) | 17 weight parts |
| 4. | A bisphenol Z-type polycarbonate (formula (2)) with a viscosity average | 59 weight parts. |
| | molecular weight Mv 20,000 | |

### Embodiment 21

A sample was created by the exact same procedure as Embodiment 1, except that the composition of the coating solution was changed as follows.

Preparation of the coating solution

| | | |
|---|---|---|
| 1. | A titanyl phthalocyanine having strong diffraction peaks at 2 θ = 7.5 ± 0.2 | 1 weight part |
| | degrees, 12.3 ± 0.2 degrees, 16.3 ± 0.2 degrees, | |
| | 25.3 ± 0.2 degrees, 28.7 ± 0.2 degrees | |
| | in a powder X-ray diffraction pattern using Cu-Kα rays (formula (1)) | |
| 2. | A hole transport agent shown in (HT1-10) | 41 weight parts |
| 3. | An electron transport agent shown in (ET2-1) | 29 weight parts |
| 4. | A bisphenol Z-type polycarbonate (formula (2)) with a viscosity average | 29 weight parts. |
| | molecular weight Mv 16,000 | |

### Embodiment 22

A sample was created by the exact same procedure as Embodiment 1, except that the composition of the coating solution was changed as follows.

Preparation of the coating solution

| | | |
|---|---|---|
| 1. | A titanyl phthalocyanine having strong diffraction peaks at 2 θ = 7.5 ± 0.2 | 1 weight part |
| | degrees, 12.3 ± 0.2 degrees, 16.3 ± 0.2 degrees, | |
| | 25.3 ± 0.2 degrees, 28.7 ± 0.2 degrees | |
| | in a powder X-ray diffraction pattern using Cu-Kα rays (formula (1)) | |
| 2. | A hole transport agent shown in (HT1-10) | 34.5 weight parts |
| 3. | An electron transport agent shown in (ET2-1) | 24.5 weight parts |
| 4. | A bisphenol Z-type polycarbonate (formula (2)) with a viscosity average | 40 weight parts. |
| | molecular weight Mv 16,000 | |

### Embodiment 23

A sample was created by the exact same procedure as Embodiment 1, except that the composition of the coating solution was changed as follows.

Preparation of the coating solution

| | | |
|---|---|---|
| 1. | A titanyl phthalocyanine having strong diffraction peaks at 2 θ = 7.5 ± 0.2 | 1 weight part |
| | degrees, 12.3 ± 0.2 degrees, 16.3 ± 0.2 degrees, | |
| | 25.3 ± 0.2 degrees, 28.7 ± 0.2 degrees | |
| | in a powder X-ray diffraction pattern using Cu-Kα rays (formula (1)) | |
| 2. | A hole transport agent shown in (HT1-10) | 41 weight parts |
| 3. | An electron transport agent shown in (ET2-1) | 29 weight parts |
| 4. | A bisphenol Z-type polycarbonate (formula (2)) | 29 weight parts. |
| | with a viscosity average molecular weight Mv 50,000 | |

### Embodiment 24

A sample was created by the exact same procedure as Embodiment 1, except that the composition of the coating solution was changed as follows.

Preparation of the coating solution

| | | |
|---|---|---|
| 1. | A titanyl phthalocyanine having strong diffraction peaks at 2 θ = 7.5 ± 0.2 | 1 weight part |
| | degrees, 12.3 ± 0.2 degrees, 16.3 ± 0.2 degrees, | |
| | 25.3 ± 0.2 degrees, 28.7 ± 0.2 degrees | |
| | in a powder X-ray diffraction pattern using Cu-Kα rays (formula (1)) | |
| 2. | A hole transport agent shown in (HT1-10) | 34.5 weight parts |
| 3. | An electron transport agent shown in (ET2-1) | 24.5 weight parts |
| 4. | A bisphenol Z-type polycarbonate (formula (2)) | 40 weight parts. |
| | with a viscosity average molecular weight Mv 50,000 (formula (2)) | |

### Embodiment 25

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT1-10) | 41 weight parts |
| 3. | An electron transport agent shown in (ET2-1) | 29 weight parts |
| 4. | A bisphenol A-biphenyl copolymer polycarbonate (formula (3)) | 29 weight parts. |
| | with a viscosity average molecular weight Mv 16,000 | |

### Embodiment 26

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT1-10) | 34.5 weight parts |
| 3. | An electron transport agent shown in (ET2-1) | 24.5 weight parts |
| 4. | A bisphenol A-biphenyl copolymer polycarbonate (formula (3)) with a viscosity | 40 weight parts. |
| | average molecular weight Mv 16,000 | |

### Embodiment 27

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT1-10) | 41 weight parts |
| 3. | An electron transport agent shown in (ET2-1) | 29 weight parts |
| 4. | A bisphenol A-biphenyl copolymer polycarbonate (formula (3)) with a viscosity | 29 weight parts. |
| | average molecular weight Mv 36,000 | |

### Embodiment 28

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT1-10) | 34.5 weight parts |
| 3. | An electron transport agent shown in (ET2-1) | 24.5 weight parts |
| 4. | A bisphenol A-biphenyl copolymer polycarbonate (formula (3)) with a viscosity | 40 weight parts. |
| | average molecular weight Mv 36,000 | |

### Embodiment 29

A sample was created by the exact same procedure as Embodiment 1, except that the composition of the coating solution was changed as follows. Preparation of the coating solution

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT1-10) | 34.5 weight parts |
| 3. | An electron transport agent shown in (ET2-1) | 24.5 weight parts |
| 4. | A bisphenol A-biphenyl copolymer polycarbonate (formula (3)) with a viscosity | 40 weight parts. |
| | average molecular weight Mv 50,000 | |

### Embodiment 30

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT1-10) | 41 weight parts |
| 3. | An electron transport agent shown in (ET2-1) | 29 weight parts |
| 4. | A bisphenol A-biphenyl system ternary copolymer polycarbonate (formula (4)) | 29 weight parts. |
| | with a viscosity average molecular weight Mv 19,000 | |

### Embodiment 31

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT1-10) | 41 weight parts |
| 3. | An electron transport agent shown in (ET2-1) | 29 weight parts |
| 4. | A bisphenol A-biphenyl system ternary copolymer polycarbonate (formula (4)) | 29 weight parts. |
| | with a viscosity average molecular weight Mv 50,000 | |

### Embodiment 32

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT1-10) | 34.5 weight parts |
| 3. | An electron transport agent shown in (ET2-1) | 24.5 weight parts |
| 4. | A bisphenol A-biphenyl system ternary copolymer polycarbonate (formula (4)) | 40 weight parts. |
| | with a viscosity average molecular weight Mv 50,000 | |

### Embodiment 33

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT4-2) | 34.5 weight parts |
| 3. | An electron transport agent shown in (ET2-1) | 24.5 weight parts |
| 4. | A bisphenol Z type polycarbonate (formula (2)) with a viscosity average | 40 weight parts. |
| | molecular weight Mv 50,000 | |

### Embodiment 34

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT2-12) | 34.5 weight parts |
| 3. | An electron transport agent shown in (ET2-1) | 24.5 weight parts |
| 4. | A bisphenol Z type polycarbonate (formula (2)) with a viscosity average | 40 weight parts. |
| | molecular weight Mv 50,000 | |

### Embodiment 35

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT3-6) | 34.5 weight parts |
| 3. | An electron transport agent shown in (ET2-1) | 24.5 weight parts |
| 4. | A bisphenol Z type polycarbonate (formula (2)) with a viscosity average | 40 weight parts. |
| | molecular weight Mv 50,000 | |

### Embodiment 36

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT1-10) | 34.5 weight parts |
| 3. | An electron transport agent shown in (ET1-3) | 24.5 weight parts |
| 4. | A bisphenol Z type polycarbonate (formula (2)) with a viscosity average | 40 weight parts. |
| | molecular weight Mv 50,000 | |

### Embodiment 37

A sample was created by the exact same procedure as Embodiment 1, except that the composition of the coating solution was changed as follows.

Preparation of the coating solution

| | | |
|---|---|---|
| 1. | A titanyl phthalocyanine having a maximum diffraction peak of 2 θ = 27.3 ± 0.2 | 1 weight part |
| | degrees in a powder X-ray diffraction pattern using Cu-Kα rays (formula (1)) | |
| 2. | A hole transport agent shown in (HT1-10) | 34.5 weight parts |
| 3. | An electron transport agent shown in (ET3-1) | 24.5 weight parts |
| 4. | A bisphenol Z type polycarbonate (formula (2)) with a viscosity average | 40 weight parts. |
| | molecular weight Mv 50,000 | |

### Comparative Example 1

A sample was created by the exact same procedure as Embodiment 1, except that the composition of the coating solution was changed as follows.

Preparation of the coating solution

| | | |
|---|---|---|
| 1. | An X-type metal-free phthalocyanine | 1 weight part |
| 2. | A hole transport agent shown in (HT1-10) | 34.5 weight parts |
| 3. | An electron transport agent shown in (ET2-1) | 24.5 weight parts |
| 4. | A bisphenol Z type polycarbonate (formula (2)) | 40 weight parts. |
| | with a viscosity average molecular | |
| | weight Mv 20,000 | |

### Comparative Example 2

A sample was created by the exact same procedure as Embodiment 1, except that the composition of the coating solution was changed as follows.

Preparation of the coating solution

| | | |
|---|---|---|
| 1. | An X-type metal-free phthalocyanine | 1 weight part |
| 2. | A hole transport agent shown in (HT1-10) | 29 weight parts |
| 3. | An electron transport agent shown in (ET2-1) | 21 weight parts |
| 4. | A bisphenol Z type polycarbonate (formula (2)) | 49 weight parts. |
| | with a viscosity average molecular | |
| | weight Mv 20,000 | |

### Comparative Example 3

A sample was created by the exact same procedure as Embodiment 1, except that the composition of the coating solution was changed as follows.

Preparation of the coating solution

| | | |
|---|---|---|
| 1. | An X-type metal-free phthalocyanine | 1 weight part |
| 2. | A hole transport agent shown in (HT1-10) | 23 weight parts |
| 3. | An electron transport agent shown in (ET2-1) | 17 weight parts |
| 4. | A bisphenol Z type polycarbonate (formula (2)) | 59 weight parts. |
| | with a viscosity average molecular | |
| | weight Mv 20,000 | |

### Comparative Example 4

A sample was created by the exact same procedure as Embodiment 1, except that the composition of the coating solution was changed as follows.

Preparation of the coating solution

| | | |
|---|---|---|
| 1. | A beta-type metal-free phthalocyanine | 1 weight part |
| 2. | A hole transport agent shown in (HT1-10) | 34.5 weight parts |
| 3. | An electron transport agent shown in (ET2-1) | 24.5 weight parts |
| 4. | A bisphenol Z type polycarbonate (formula (2)) | 40 weight parts. |
| | with a viscosity average molecular | |
| | weight Mv 20,000 | |

### Comparative Example 5

A sample was created by the exact same procedure as Embodiment 1, except that the composition of the coating solution was changed as follows.

Preparation of the coating solution

| | | |
|---|---|---|
| 1. A beta-type metal-free phthalocyanine | 1 | weight part |
| 2. A hole transport agent shown in (HT1-10) | 29 | weight parts |
| 3. An electron transport agent shown in (ET2-1) | 21 | weight parts |
| 4. A bisphenol Z type polycarbonate (formula (2)) | 49 | weight parts. |
| with a viscosity average molecular weight Mv 20,000 | | |

### Comparative Example 6

A sample was created by the exact same procedure as Embodiment 1, except that the composition of the coating solution was changed as follows.

Preparation of the coating solution

| | | |
|---|---|---|
| 1. A beta-type metal-free phthalocyanine | 1 | weight part |
| 2. A hole transport agent shown in (HT1-10) | 23 | weight parts |
| 3. An electron transport agent shown in (ET2-1) | 17 | weight parts |
| 4. A bisphenol Z type polycarbonate (formula (2)) | 59 | weight parts. |
| with a viscosity average molecular weight Mv 20,000 | | |

### Comparative Example 7

A sample was created by the exact same procedure as Embodiment 1, except that the composition of the coating solution was changed as follows.

Preparation of the coating solution

| 1. A titanyl phthalocyanine having a maximum | 1 | weight part |
|---|---|---|
| diffraction peak of 2 θ = 27.3 ± 0.2 degrees in a | | |
| powder X-ray diffraction pattern using Cu—Kα rays | | |
| (formula(1)) | | |
| 2. A hole transport agent shown in (HT1-10) | 59 | weight parts |
| 3. An electron transport agent | none | |
| 4. A bisphenol Z-type polycarbonate (formula (2)) | 40 | weight parts. |
| with a viscosity average molecular weight Mv 50,000 | | |

Evaluation method

The methods for evaluating the samples created in the above embodiments and comparative examples are described below.

Stretch test

Using a commercial stretch test device, both ends of the photosensitive body sheet with a width of 10 mm and length (perimeter) of 50 mm as described above were anchored. A tension was applied in the longitudinal direction of this sheet, and the tension was gradually increased. The tension value at which cracking began on the photosensitive layer surface of this sheet was measured by visual examination. Together with this, the photosensitive body properties (sensitivity) of this photosensitive body sheet were measured prior to the test and also after removing from the test device once cracking was confirmed.

Evaluation of the photosensitive body properties in the belt condition

The photosensitive body properties (half decay exposure (sensitivity), dark attenuation rate 5 seconds after light exposure) were measured for the photosensitive body belt with a width of 250 mm, circumference of 942 mm as described above.

Bending test

The photosensitive body belt of a width 250 mm and circumference 400 mm as described above was wrapped around two top and bottom cylindrical rollers. The top roller was anchored, and a load of 50 N/cm per unit length of the width of the photosensitive body was applied to the bottom roller. While visually observing the surface conditions of the photosensitive film of the photosensitive body belt, the diameter of the top roller was changed. The diameter of the top roller when cracking on the photosensitive layer surface was seen by visual observation was determined. Together with this, as with the previous stretch test, the photosensitive body properties (sensitivity) for the photosensitive body belt were measured prior to the test as well as after removing from the test device after cracking was confirmed.

Repeat operation test within the test machine

In order to make a test device, a commercial color printer in which a negatively charged photosensitive body belt was mounted was transformed to a positively charging type. A photosensitive body belt with a width of 360 mm and circumference of 560 mm as described above was mounted and operated continuously. The repeat number when cracking was observed by visual inspection on the photosensitive body surface was determined.

Referring to Tables 1 through 4, results from each of the above tests for the embodiments are shown. Referring to Tables 5 and 6, the results for the comparative examples are shown.

TABLE 1

| | | sensitivity (half decay | | | |
|---|---|---|---|---|---|
| | Stretch test | exposure) | | Photosensitive body property | |
| | Tension when | | At the time | Sensitivity (half | Dark attenuation |
| | cracking began | Initial | of cracking | decay exposure | rate after 5 |
| | (N/cm) | (μJ/cm²) | (μJ/cm²) | (μJ/cm²) | seconds (%) |
| Emb. 1 | 45 | 0.12 | 0.13 | 0.12 | 87.2 |
| Emb. 2 | 55 | 0.15 | 0.16 | 0.14 | 87.0 |
| Emb. 3 | 60 | 0.19 | 0.21 | 0.19 | 87.8 |
| Emb. 4 | 70 | 0.20 | 0.23 | 0.21 | 88.2 |
| Emb. 5 | 40 | 0.13 | 0.14 | 0.13 | 87.4 |
| Emb. 6 | 53 | 0.16 | 0.17 | 0.17 | 88.4 |
| Emb. 7 | 59 | 0.13 | 0.14 | 0.15 | 87.5 |
| Emb. 8 | 68 | 0.15 | 0.15 | 0.18 | 88.5 |
| Emb. 9 | 46 | 0.16 | 0.17 | 0.16 | 87.9 |
| Emb. 10 | 56 | 0.17 | 0.18 | 0.17 | 88.2 |
| Emb. 11 | 61 | 0.19 | 0.19 | 0.19 | 88.8 |
| Emb. 12 | 72 | 0.21 | 0.22 | 0.20 | 88.7 |
| Emb. 13 | 41 | 0.16 | 0.17 | 0.16 | 87.7 |
| Emb. 14 | 53 | 0.17 | 0.18 | 0.17 | 88.7 |
| Emb. 15 | 60 | 0.15 | 0.16 | 0.14 | 87.0 |
| Emb. 16 | 71 | 0.18 | 0.19 | 0.18 | 87.8 |
| Emb. 17 | 47 | 0.12 | 0.12 | 0.12 | 87.2 |
| Emb. 18 | 58 | 0.14 | 0.15 | 0.15 | 88.5 |
| Emb. 19 | 62 | 0.17 | 0.17 | 0.17 | 88.3 |

TABLE 2

| | | sensitivity (half decay | | | |
|---|---|---|---|---|---|
| | Stretch test | exposure) | | Photosensitive body property | |
| | Tension when | | At the time | Sensitivity (half | Dark attenuation |
| | cracking began | Initial | of cracking | decay exposure | rate after 5 |
| | (N/cm) | (μJ/cm²) | (μJ/cm²) | (μJ/cm²) | seconds (%) |
| Emb. 20 | 73 | 0.19 | 0.20 | 0.19 | 88.9 |
| Emb. 21 | 43 | 0.12 | 0.12 | 0.12 | 87.5 |
| Emb. 22 | 55 | 0.14 | 0.14 | 0.14 | 87.9 |
| Emb. 23 | 59 | 0.11 | 0.12 | 0.12 | 87.9 |
| Emb. 24 | 70 | 0.15 | 0.15 | 0.16 | 88.9 |
| Emb. 25 | 49 | 0.13 | 0.14 | 0.14 | 87.8 |
| Emb. 26 | 54 | 0.15 | 0.15 | 0.16 | 88.3 |
| Emb. 27 | 63 | 0.13 | 0.13 | 0.13 | 87.7 |
| Emb. 28 | 68 | 0.16 | 0.17 | 0.16 | 88.3 |
| Emb. 29 | 77 | 0.16 | 0.16 | 0.16 | 88.7 |
| Emb. 30 | 50 | 0.13 | 0.14 | 0.14 | 87.9 |
| Emb. 31 | 51 | 0.12 | 0.13 | 0.12 | 88.0 |
| Emb. 32 | 74 | 0.16 | 0.16 | 0.17 | 88.8 |
| Emb. 33 | 67 | 0.15 | 0.16 | 0.15 | 87.3 |
| Emb. 34 | 69 | 0.17 | 0.18 | 0.18 | 87.7 |
| Emb. 35 | 69 | 0.14 | 0.15 | 0.15 | 87.6 |
| Emb. 36 | 68 | 0.14 | 0.15 | 0.14 | 87.3 |
| Emb. 37 | 67 | 0.16 | 0.17 | 0.16 | 87.3 |

TABLE 3

| | Bending test | | photosensitive body | repeat operation |
|---|---|---|---|---|
| | roller diameter at | sensitivity (half | property | test |
| | the time of | decay exposure) | Sensitivity at the time | Number of times |
| | cracking (mmΦ) | Initial (μJ/cm²) | of cracking (μJ/cm²) | until cracking |
| Emb. 1 | 15 | 0.12 | 0.20 | 25000 |
| Emb. 2 | 10 | 0.15 | 0.16 | 30000 |
| Emb. 3 | 5 | 0.18 | 0.20 | 35000 |
| Emb. 4 | 5 | 0.21 | 0.22 | 37000 |
| Emb. 5 | 20 | 0.13 | 0.25 | 23000 |
| Emb. 6 | 15 | 0.17 | 0.18 | 30000 |
| Emb. 7 | 10 | 0.15 | 0.18 | 27000 |
| Emb. 8 | 5 | 0.18 | 0.19 | 36000 |
| Emb. 9 | 15 | 0.16 | 0.24 | 25000 |
| Emb. 10 | 10 | 0.16 | 0.18 | 31000 |
| Emb. 11 | 5 | 0.18 | 0.19 | 35000 |
| Emb. 12 | 5 | 0.20 | 0.20 | 36000 |
| Emb. 13 | 20 | 0.16 | 0.27 | 22000 |
| Emb. 14 | 15 | 0.20 | 0.21 | 26000 |
| Emb. 15 | 10 | 0.14 | 0.16 | 28000 |
| Emb. 16 | 5 | 0.18 | 0.18 | 36000 |
| Emb. 17 | 15 | 0.18 | 0.25 | 23000 |
| Emb. 18 | 10 | 0.20 | 0.22 | 29000 |
| Emb. 19 | 5 | 0.23 | 0.24 | 34000 |

TABLE 4

| | Bending test | | photosensitive body | repeat operation |
|---|---|---|---|---|
| | roller diameter at | sensitivity (half | property | test |
| | the time of | decay exposure) | Sensitivity at the time | Number of times |
| | cracking (mmΦ) | Initial (μJ/cm²) | of cracking (μJ/cm²) | until cracking |
| Emb. 20 | 5 | 0.22 | 0.22 | 36000 |
| Emb. 21 | 20 | 0.19 | 0.30 | 22000 |
| Emb. 22 | 15 | 0.20 | 0.21 | 34000 |
| Emb. 23 | 20 | 0.19 | 0.22 | 24000 |
| Emb. 24 | 5 | 0.22 | 0.22 | 36000 |
| Emb. 25 | 15 | 0.15 | 0.25 | 21000 |
| Emb. 26 | 10 | 0.17 | 0.18 | 27000 |
| Emb. 27 | 10 | 0.15 | 0.20 | 28000 |
| Emb. 28 | 5 | 0.18 | 0.18 | 35000 |
| Emb. 29 | 5 | 0.19 | 0.19 | 36000 |
| Emb. 30 | 15 | 0.20 | 0.28 | 25000 |
| Emb. 31 | 10 | 0.20 | 0.23 | 28000 |
| Emb. 32 | 5 | 0.21 | 0.21 | 37000 |
| Emb. 33 | 5 | 0.16 | 0.16 | 38000 |
| Emb. 34 | 5 | 0.17 | 0.18 | 37000 |
| Emb. 35 | 5 | 0.15 | 0.16 | 36000 |
| Emb. 36 | 5 | 0.15 | 0.16 | 37000 |
| Emb. 37 | 5 | 0.18 | 0.19 | 38000 |

TABLE 5

| | | sensitivity (half decay | | | |
|---|---|---|---|---|---|
| | Stretch test | exposure) | | Photosensitive body property | |
| | Tension when | | At the time | Sensitivity (half | Dark attenuation |
| | cracking began | Initial | of cracking | decay exposure | rate after 5 |
| | (N/cm) | (μJ/cm²) | (μJ/cm²) | (μJ/cm²) | seconds (%) |
| Comp. Ex. 1 | 30 | 0.40 | 0.70 | 0.41 | 85.2 |
| Comp. Ex. 2 | 32 | 0.45 | 0.69 | 0.44 | 84.3 |
| Comp. Ex. 3 | 34 | 0.47 | 0.67 | 0.48 | 87.1 |
| Comp. Ex. 4 | 29 | 0.78 | 1.12 | 0.77 | 78.5 |
| Comp. Ex. 5 | 30 | 0.85 | 1.15 | 0.85 | 79.8 |
| Comp. Ex. 6 | 33 | 0.90 | 1.14 | 0.93 | 78.3 |
| Comp. Ex. 7 | 64 | 1.12 | 1.15 | 1.13 | 83.3 |

TABLE 6

| | Bending test | | photosensitive body | repeat operation |
|---|---|---|---|---|
| | roller diameter at | sensitivity (half | property | test |
| | the time of | decay exposure) | Sensitivity at the time | Number of times |
| | cracking (mmΦ) | Initial (μJ/cm²) | of cracking (μJ/cm²) | until cracking |
| Comp. Ex. 1 | 35 | 0.41 | 0.87 | 16000 |
| Comp. Ex. 2 | 35 | 0.44 | 0.82 | 17000 |
| Comp. Ex. 3 | 30 | 0.48 | 0.78 | 18000 |
| Comp. Ex. 4 | 35 | 0.79 | 1.25 | 13000 |
| Comp. Ex. 5 | 35 | 0.86 | 1.18 | 15000 |
| Comp. Ex. 6 | 35 | 0.89 | 1.23 | 16000 |
| Comp. Ex. 7 | 10 | 1.09 | 1.13 | 35000 |

Referring to Tables 1-6, the following results can be seen.

With regard to the effect of cracks on the sensitivity and the ease of generation of cracks, when Embodiments 1-37 which use a titanyl phthalocyanine relating to the present invention as the charge generating agent and Comparative examples 1-6 which use metal-free phthalocyanine are compared, the samples of the comparative examples had cracks starting at a low tension of 29-34 N/cm in the stretching test. In addition, when comparing the change in sensitivity between the initial sensitivity and the sensitivity at the time of the cracking, the effect of cracks on the sensitivity was large for the samples of the comparative examples. In addition, with the bending test as well, with the samples of Comparative examples 1-6, cracks were generated even at large diameters for the cylindrical roller of 30-35 mm Φ. From the repeat operation test, the repeat number at which cracks were generated was low at 13000-18000 times. In contrast, with the embodiments of the present invention which used titanyl phthalocyanine, the tension at which cracks began was large at 40-77 N/cm, and with the latter bending test, the diameter of the cylindrical roller at which cracks began was a small diameter of 5-20 mm Φ. In addition, with the repeat operation test, the .repeat number at which cracking began was a large number of21000-38000 times. With regard to the effect on sensitivity, the change in sensitivity between the initial sensitivity and the sensitivity at the time of cracking was small, and it can be seen that the effect is small. By using titanyl phthalocyanine as a charge generating agent, not only is the sensitivity improved, but surprisingly, there are also advantages of a reduction in the cracking of the photosensitive layer and a reduction in the effect of cracking on the sensitivity.

In addition, with the embodiments, Embodiments 2-4, 6, 8, 10-12, 14, 16, 18-20, 22, 24, 26, 28, 29, 32, 33-37 have a weight ratio for polycarbonate resin of 40% or greater, have a viscosity average molecular weight for the same resin of 20,000 or greater, and use titanyl phthalocyanine. When these embodiments are compared with the other embodiments, in the stretching test, the former had a tension at the time of cracking of 50 N/cm or greater per unit length of the width of the photosensitive body. In addition, in the bending test, the diameter of the cylindrical roller at the time of cracking was 5-20 mm Φ. Therefore, rollers with a diameter of 20 mm Φ or less and 5 mm Φ or greater can be used. Even with these small diameter rollers, there were essentially no cracks in the belt photosensitive body resulting from the stress from the cylindrical rollers that could have an effect on the electrophotography properties. As a result, this is preferable particularly in terms of miniaturizing, colorizing, and increasing the speed of the image forming device.

Furthermore, when Embodiment 1 which contains an electron transport agent is compared with Comparative Example 7 which does not, the electron transport agent relating to the present invention clearly has a large effect on the sensitivity. The importance of the electron transport agent in the present invention can be understood.

Therefore, as seen from these results, the endless flexible single-layer positively charged organic photosensitive body of the present invention of one of claims 2 through 4 can be used in an image forming device such as color capable and high speed printers, copiers, fax machines, light printing presses, and the like. In these devices, the photosensitive body is stretched across a plurality of cylindrical rollers that have a tension of 50 N/cm or greater per unit length of the width of the photosensitive body and/or include a roller of an outer diameter of 5 mm or greater and 20 mm or less.

Furthermore, with the embodiments described above, although not shown in the test results of Tables 1-6, a better cracking resistance is achieved when the molecular weight distribution range of the polycarbonate resin relating to the present invention is narrow. Preferably, the range is within approximately the molecular weight +10%. Furthermore, with Embodiments 33 through 37, not many examples of different types of hole transport agents and electron transport agents are given. However, although there are differences in properties depending on the types of charge transport agents, all of them confirmed the advantages of the invention.

According to the present invention, this is an endless flexible single-layer positively charged organic photosensitive body, wherein: a photosensitive layer, which has main construction material of a charge generating agent, a hole transport agent, an electron transport agent, and a resin binder, is formed on top of a flexible support body; the charge generating agent contains mainly titanyl phthalocyanine; and the resin binder contains polycarbonate resin as a main resin. As a result, the present invention provides an endless flexible single-layer positively charge organic photosensitive body and an image forming device using the same, wherein: in an image forming device that is small, high speed and capable of color output, even when tension and compression forces, which are generated by having the photosensitive body stretched between a plurality of cylindrical rollers, are repeatedly applied to the belt photosensitive body, no problems arise in the electrophotography properties of the photosensitive layer.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An endless flexible single-layer positively charged organic photosensitive body, comprising:
a photosensitive layer, said photosensitive layer including a charge generating agent, a hole transport agent, an electron transport agent, and a resin binder;
a flexible support body;
said photosensitive layer being formed on top of said flexible support body;
said charge generating agent comprises titanyl phthalocyanine;
and said resin binder comprises a polycarbonate resin.

2. An endless flexible single-layer positively charged organic photosensitive body as described in claim 1, wherein:
said polycarbonate resin has at least one of (a) a viscosity average molecular weight of 20,000 or greater and (b) a weight ratio of said polycarbonate resin in said photosensitive layer is 40% or greater and 70% or less.

3. An endless flexible single-layer positively charged organic photosensitive body as described in claim 1, wherein:
said polycarbonate resin is a bisphenol Z-type polycarbonate resin.

4. An endless flexible single-layer positively charged organic photosensitive body as described in claim 2, wherein:
said polycarbonate resin is a bisphenol Z-type polycarbonate resin.

5. An image forming device, comprising:
an endless flexible single-layer positively charged organic photosensitive body as described in claim 1, that is stretched over a plurality of cylindrical rollers that include at least one cylindrical roller with an outer diameter of 5 mm phi or greater and 20 mm phi or less;
and means for electrophotography processing that are placed on the periphery of said photosensitive body.

6. An image forming device, comprising:
an endless flexible single-layer positively charged organic photosensitive body as described in claim 1 that is stretched with a tension of 50 N/cm per unit length of the width of said photosensitive body and is stretched over a plurality of cylindrical rollers that include at least one cylindrical roller with an outer diameter of 5 mm phi or greater and 20 mm phi or less;
and means for electrophotography processing that are placed on the periphery of said photosensitive body.

7. An image forming device as described in claim 5, wherein:
said image forming device is a device selected from a printer, copier, fax machine, and printing press that are capable of color output by an electrophotography method.
